(19) United States
(12) Patent Application Publication
(10) Pub. No.: US 2002/0034302 A1
(43) Pub. Date: Mar. 21, 2002

(54) Data terminal device that can easily obtain and reproduce desired data

(75) Inventors: Shinsuke Moriai, Inuyama-shi (JP); Yoshihiro Hori, Gifu-shi (JP)

Correspondence Address: ARMSTRONG,WESTERMAN & HATTORI, LLP, 1725 K STREET, NW., SUITE 1000, WASHINGTON, DC, 20006, US

(73) Assignee: Sanyo Electric Co., Ltd., Moriguchi-shi (JP)

(21) Appl. No.: 09/947,390

(22) Filed: Sep. 7, 2001

(30) Foreign Application Priority Data
Sep. 18, 2000 (JP) 2000-281464 ( P )

(51) Int. Cl. H04K 1/00

(52) U.S. Cl. 380/270

(57) ABSTRACT

A remote controller is connected to a cellular phone. A memory card is loaded in the remote controller. A headphone is connected to the remote controller. The cellular phone receives encrypted content data and a license key used to decrypt the encrypted content data from a distribution server and transmits the encrypted content data and license key to the remote controller. The remote controller records the received license key and encrypted content data into a memory card. The remote controller reads out and reproduces the license key and encrypted content data from the memory card for output to the headphone. Thus, a data terminal device of high usability that allows the user to easily obtain and reproduce the desired data can be provided.

### BACKGROUND OF THE INVENTION

1. Field of the Invention

The present invention relates to a data terminal device and headphone device used in a data distribution system that allows protection on copyrights with respect to copied information.

2. Description of the Background Art

By virtue of the progress in information communication networks and the like such as the Internet in these few years, each user can now easily access network information through individual-oriented terminals employing a cellular phone or the like.

In such information communication networks, information is transmitted through digital signals. It is now possible to obtain copied music and video information transmitted via the aforementioned information communication network without degradation in the audio quality and picture quality of the copy information, even in the case where the copy operation is performed by an individual user.

Thus, there is a possibility of the copyright of the copyright owner being significantly infringed unless some appropriate measures to protect copyrights are taken when any created work subject to copyright protection such as music and image information is to be transmitted on the information communication network.

However, if copyright protection is given top priority so that distribution of copyrighted data through the disseminating digital information communication network is suppressed, the copyright owner who can essentially collect a predetermined copyright royalty for copies of a copyrighted work will also incur some disbenefit.

Consider the case of a recording medium recorded with digital information instead of the above-described distribution through a digital information communication network. As to the commercially-available CDs (Compact Disks) recorded with music information, copying music information from a CD to a magneto-optical disk (MD) can be carried out basically arbitrarily as long as the copied music is used only for individual usage. Although indirectly, the individual user conducting digital recording and the like pays as a compensation a predetermined amount out of the cost of the digital recording equipment per se or the recording medium such as the MD to the copyright owner.

Based on the fact that the resultant music information constituted by digital signals, when copied from a CD to a MD, corresponds to digital data with almost no degradation through the copy operation, copying music data from one MD to another MD as digital information is disabled due to configuration constraints on the apparatus for the purpose of protecting copyright owners.

In view of the foregoing, sufficient measures must be taken in distributing music and image information to the public through the digital information communication network for the purpose of copyright protection since distribution per se is an act subject to restriction based on the copyright owner's right of transmission to the public.

In this case, it is necessary to prevent content data such as music data and image data that are copyrighted works transmitted to the public through an information communication network, when once received, from being further copied without permission.

To this end, a data distribution system is proposed in which a distribution server retaining encrypted content data which is an encrypted version of content data distributes the encrypted content data through a terminal device such as a cellular phone to a memory card loaded in the terminal device. In this data distribution system, a public encryption key of a memory card authenticated in advance by a certificate authority and a certificate thereof are sent to the distribution server when distribution of encrypted content data is requested. Upon confirming reception of an authorized certificate by the distribution server, the encrypted content data and a license key required to decrypt the encrypted content data are transmitted to the memory card. In distributing the encrypted content data and license key, the distribution server and memory card generate a session key differing for each distribution. The public encryption key is encrypted using the generated session key, and the key is exchanged between the distribution server and memory card.

Eventually, the distribution server transmits a license encrypted using a public encryption key unique to each memory card and further encrypted using a session key, as well as the encrypted content data to the memory card. The memory card records the received license and encrypted content data into the memory.

When the encrypted content data stored in the memory is to be reproduced, the memory card is loaded in a cellular phone. The cellular phone includes a dedicated circuit to decrypt and reproduce the encrypted content data from the memory card for output in addition to the general telephone function. In reproducing the piece of music distributed from the distribution server to the memory card, the user must hold the cellular phone near his/her ear to listen to the music in a manner similar to that of placing a call through a cellular phone.

In general, the time required to reproduce one song is approximately three to five minutes. If the user is to listen to about 10 songs continuously, the user must hold the cellular phone close to his/her ear for approximately thirty to fifty minutes, which is extremely inconvenient. It is particularly not convenient when the music is to be played continuously when walking outside.

In the case where desired data is to be distributed from the distribution server when walking outside, the user had to take out the cellular phone and access the distribution server, which is extremely inconvenient.

### SUMMARY OF THE INVENTION

In view of the foregoing, an object of the present invention is to provide a data terminal device of high usability that allows the user to easily obtain the desired data and reproduce the obtained data.

According to an aspect of the present invention, a data terminal device receives encrypted data which is an encrypted version of data and a license key which is a decryption key used to decrypt encrypted data from a portable terminal apparatus that receives the encrypted data and license key to send the received encrypted data and license key to a data recording device, and reproduce the encrypted data from the data recording device. The data terminal device includes a first interface unit to transfer data with the portable terminal apparatus, a second interface unit to transfer data with the data recording device, an authentication data hold unit holding a preassigned authentication data output to the data recording device, a decryption processing unit decrypting encrypted data using a license key, and a control unit. In a data distribution mode, the control unit receives encrypted data and a license key from the portable terminal apparatus via the first interface unit and sends the received encrypted data and license key to the data recording device through the second interface unit. In a data reproduction mode, the control unit sends the authentication data to the data recording device through the second interface unit and receives a license key and encrypted data sent from the data recording device in response to the authenticity of the authentication data being verified at the data recording device to apply the received license key and encrypted data to the decryption processing unit.

The data terminal device of the present invention receives from a portable terminal apparatus such as a cellular phone encrypted data and a license key used to decode the encrypted data, which are received by the terminal device, and transmits the received license key and encrypted data to the data recording device in a data distribution mode. In a data reproduction mode, the data terminal device receives a license key and encrypted data from the data recording device after the authenticity of the data recording device is verified. The data terminal device decrypts the encrypted data using the license key for reproduction.

According to the present invention, the portable terminal apparatus that receives encrypted data and a license key from a distribution server and the data terminal device that decrypts and reproduces encrypted data can be provided as separate elements. As a result, the user does not have to operate the portable terminal apparatus in order to decrypt and reproduce encrypted data. The user can decrypt and reproduce encrypted data by just operating the data terminal device.

Preferably, the first interface unit of the data terminal device receives driving power from the portable terminal apparatus.

Each component configuring the data terminal device is driven by the driving power supplied from the portable terminal apparatus.

By setting the portable terminal apparatus in a drive mode, the encrypted data and license data received from the distribution server through the data terminal device can be recorded into the data recording device. Also, the encrypted data and license key can be read out from the data recording device to allow decryption and reproduction of encrypted data.

Preferably, the data terminal device further includes a power control unit controlling the driving power.

The data terminal device has a unique drive power. The power control unit controls the driving power supplied to each component configuring the data terminal device.

According to the present invention, the data terminal device can be driven independent of the portable terminal apparatus. As a result, the portable terminal apparatus does not have to be driven in reproducing encrypted data. The encrypted data can be decrypted and reproduced through just the data terminal device.

Preferably, the first interface unit of the data terminal device receives encrypted data and a license key from a portable terminal apparatus through wire.

The data terminal device is connected to a portable terminal apparatus through wire to receive the encrypted data and license data received by the portable terminal apparatus from the distribution server through wire, and transmits the received encrypted data and license key to the data recording device. In a data reproduction mode, the data terminal device reads out the encrypted data and license key from the data recording device to decrypt the encrypted data and reproduce the decrypted data.

According to the present invention, the user can reproduce encrypted data even when not at home. The user can place the portable terminal apparatus in his/her pocket or bag and attach the data terminal device to his/her clothing so as to easily operate the data terminal device. The data terminal device is connected to the portable terminal apparatus through wire. Thus, the user can easily reproduce encrypted data.

Preferably, the first interface unit of the data terminal device receives encrypted data and a license key from the portable terminal apparatus through radio communication.

The data terminal device receives through radio the encrypted data and license key received by the portable terminal apparatus from the distribution server and transmits the received encrypted data and license key to the data recording device. In a data reproduction mode, the data terminal device reads out the encrypted data and license key from the data recording device without accessing the portable terminal apparatus to decrypt and reproduce encrypted data.

According to the present invention, the encrypted data and license key can be recorded into the data recording device even if the data terminal device is not connected to the portable terminal apparatus. Encrypted data can be decrypted and reproduced by just operating the data terminal device. As a result, the user does not require wiring for connection between the data terminal device and the portable terminal apparatus in reproducing encrypted data using the data terminal device when away from home. Encrypted data can be reproduced without interrupting one's free movement.

Preferably, the data terminal device further includes a key operation unit connected to the control unit to accept a reproduction request from the user. When the control unit receives a reproduction request through the key operation unit in a data reproduction mode, authentication data is transmitted to the data recording device through the second interface unit. A license key and encryption data transmitted from the data recording device in response to the authenticity of the authentication data being verified at the data recording device are received and applied to the decryption processing unit.

In response to a reproduction request through the key operation unit, the data terminal device sends authentication data corresponding to the data recording device to the data recording device, and reads out the encrypted data and license key from the data recording device to decrypt and reproduce the encrypted data.

Preferably, the data terminal device includes a session key generator generating a first session key used to obtain a license key from the data recording device, and an encryption processing key encrypting the first session key using a second session key obtained from the data recording device based on the authenticity of authentication data being verified at the data recording device. The decryption processing unit includes a first decryption processing unit decrypting a license key encrypted using the first session key, and a second decryption processing unit decrypting the encrypted data using the license key decrypted by the first decryption processing unit. In a data reproduction mode, the control unit applies a second session key to the encryption processing unit, a license key encrypted using the first session key to the first decryption processing unit, and the encrypted data to the second decryption processing unit.

The data terminal device can obtain the encrypted data and a license key from the data recording device only after the authenticity of the data terminal device is verified at the data recording device. In obtaining the encrypted data and license key, the data terminal device generates a first session key and encrypts the generated first session key using a second session key generated by the data recording apparatus to send the encrypted first session key to the data recording device. Then, the encrypted first session key is decrypted using the second session key at the data recording device. The license key is encrypted using the decrypted first session key. The data terminal device obtains from the data recording device the encrypted data and the license key encrypted using its own generated first session key. The encrypted license key is decrypted using the first session key. The decrypted license key is used to decrypt the encrypted data.

Thus, according to the present invention, encrypted data can be decrypted and reproduced only when the data recording device is loaded in a proper data terminal device. Furthermore, mutual authentication between the data recording device and the data terminal device can be effected through session keys to allow transfer of the license key and encrypted data only when the authenticity is verified. As a result, the security can be further improved.

Preferably, the data terminal device further includes a key hold unit holding a private decryption key that is asymmetric to the public encryption key included in the authentication data, and a third decryption processing unit decrypting the second session key encrypted by the public encryption key using the private decryption key. In a data reproduction mode, the control unit receives the second session key encrypted by the public encryption key from the data recording device to provide the second session key to the third decryption processing unit and applies the second session key decrypted at the third decryption processing unit to the encryption processing unit.

At the data terminal device, authentication of the data terminal device is conducted through the public key scheme with respect to the data recording device. After the authenticity of the data terminal device is verified by the data recording device, the data terminal device receives encrypted data and a license key from the data recording device to decrypt and reproduce the encrypted data.

Thus, according to the present invention, encrypted data can be decrypted and reproduced as long as the data terminal device is legal.

Preferably, the encrypted data is encrypted music data, and the portable terminal apparatus is a cellular phone. The data terminal device further includes a music reproduction unit reproducing the music data decrypted by the decryption processing unit, and a terminal to output the music data reproduced by the music reproduction unit to an external output device.

At the data terminal device, music data encrypted with a license key is decrypted and then reproduced by the music reproduction unit to be provided to the external output device.

Thus, according to the present invention, encrypted music data can be decrypted and reproduced only through distribution of encrypted music data to a legal data recording device and by a legal data terminal device.

According to another aspect, a headphone device includes a first speaker unit with a power source, and a second speaker unit with a detach unit to load or unload a data recording device and a data terminal circuit. The data terminal circuit includes a first interface unit to transfer data with a portable terminal apparatus that receives encrypted data and a license key to decrypt the encrypted data, a second interface unit to transfer data with the data recording device, an authentication data hold unit holding authentication data for the data recording device, a decryption processing unit decrypting the encrypted data using a license key, and a control unit. In a data distribution mode, the control unit receives encrypted data and a license key from the portable terminal apparatus through the first interface unit to send the received encrypted data and license key to the data recording device via the second interface unit. In a data reproduction mode, the control unit transmits authentication data to the data recording device via the second interface unit and receives a license key and encrypted data sent from the data recording device in response to the authenticity of the authentication data being verified at the data recording device. The received license key and encrypted data are applied to the decryption processing unit.

In the headphone device of the present aspect, one of the speaker units includes a data terminal circuit to decrypt and reproduce encrypted data, and a detach unit of the data recording device. The other speaker unit includes a power source. In a data distribution mode, the data terminal circuit receives encrypted data and a license key from the portable terminal apparatus with the headphone worn on the user's head, and sends the encrypted data and license key to the loaded data recording device. In a data reproduction mode, the data terminal circuit reads out the encrypted data and license key from the data recording device with the headphone worn on the user's head to decrypt and reproduce the encrypted data.

According to the present invention, the encrypted data and license key can be recorded in the data recording device loaded to the headphone, or the encrypted data and license key can be read out from the data recording device to be decrypted and reproduced while the headphone is still worn on the user's head.

Preferably, the data recording device attached to the headphone device includes a memory storing encrypted data and a license key, an authentication key hold unit holding a public authentication key to decrypt authentication data, an authentication data decryption processing unit decrypting authentication data using a public authentication key, and a control unit. In a data reproduction mode, the control unit provides the authentication data sent from the data terminal circuit to the authentication data decryption processing unit to have the authenticity of the data terminal circuit verified based on the authentication data decrypted by the authentication data decryption processing unit. Then, the encrypted data and license key are read out from the memory to be provided to the data terminal circuit.

At the data recording device, the authentication data transmitted from the data terminal circuit is decrypted using a public authentication key to verify the authenticity of the decrypted authentication data in a data reproduction mode. Only after the authenticity of the authentication data has been verified can the encrypted data and license key stored in the memory be sent to the data terminal circuit. At the data terminal circuit, the encrypted data is decrypted using a license key to be reproduced.

Thus, according to the present invention, only a proper data terminal circuit with respect to the data recording device can decrypt and reproduce encrypted data. Thus, encrypted data can be protected sufficiently.

The foregoing and other objects, features, aspects and advantages of the present invention will become more apparent from the following detailed description of the present invention when taken in conjunction with the accompanying drawings.

### BRIEF DESCRIPTION OF THE DRAWINGS

FIG. 1 is a schematic diagram of a data distribution system.

FIGS. 2, 3 and 4 show the characteristics of data, information and the like for communication in the data distribution system of FIG. 1.

FIG. 5 is a schematic block diagram showing a structure of a license server.

FIG. 6 is a block diagram showing a structure of a cellular phone.

FIG. 7 is a block diagram showing a structure of a remote controller.

FIG. 8 is a block diagram showing a structure of a memory card.

FIGS. 9 and 10 are the first and second flow charts, respectively, to describe a distribution operation in the data distribution system of FIG. 1.

FIGS. 11 and 12 are the first and second flow charts, respectively, to describe a reproduction operation at a remote controller.

FIG. 13 is another schematic diagram to describe the principle of the data distribution system.

FIG. 14 is a diagram to describe the headphone of FIG. 13 in detail.

### DESCRIPTION OF THE PREFERRED EMBODIMENTS

Embodiments of the present invention will be described hereinafter with reference to the drawings. In the drawings, the same or corresponding components have the same reference characters allotted, and description thereof will not be repeated.

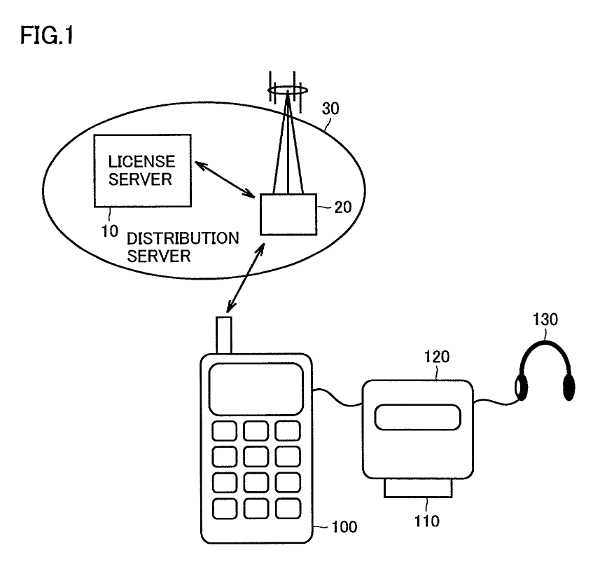

FIG. 1 is a schematic diagram of the entire structure of a data distribution system distributing encrypted content data, which is the subject of reproduction in a data terminal device according to the present invention, to a memory card.

Although the exemplified data distribution system has digital music data distributed to respective cellular phone users via a cellular phone network, the present invention is not limited to such a configuration and can be applied to the distribution of other copyrighted work such as image data and motion picture data as the content data.

Referring to FIG. 1, a distribution carrier 20 relays to a license server 10 a distribution request from respective cellular phone users obtained through its own cellular phone network. License server 10 supervising copyrighted music data confirms whether a memory card 110 loaded in a remote controller 120 of a cellular phone user who is accessing for data distribution has proper authentication data, i.e. performs an authentication process of verifying the authenticity of the memory card, and encrypts the relevant data (also called content data hereinafter) according to a predetermined encryption scheme for the proper memory card. License server 10 provides such encrypted content data and a license that is the information required to reproduce the encrypted content data to distribution carrier 20 that is a cellular phone company distributing data.

Distribution carrier 20 distributes the encrypted content data and license through the cellular phone network and cellular phone 100 to memory card 110 loaded in remote controller 120 of cellular phone 100 that has issued a distribution request through its own cellular phone network.

In FIG. 1, cellular phone 100 of a user has a remote controller 120 connected by a cable or the like. A detachable memory card 110 is loaded in remote controller 120. Remote controller 120 receives encrypted content data from cellular phone 100 and transmits the encrypted content data to memory card 110. Remote controller 120 reads out and decrypts the encrypted content data from memory card 110.

The cellular phone user can “reproduce” the content data via a headphone 130 or the like connected to remote controller 120 to listen to the music.

In the following, license server 10 and distribution carrier 20 will be generically referred to as distribution server 30.

The process of transmitting content data to respective cellular phones and the like from distribution server 30 is referred to as “distribution”.

By such a structure, it is difficult to receive distribution of content data from distribution server 30 to reproduce music unless memory card 110 is not employed.

By counting the number of times of distributing content data, for example, one song, at distribution carrier 20, and collecting the copyright fee every time a cellular phone user receives (downloads) content data in the form of telephone bills for respective cellular phones, the copyright fee of the copyright owner can be ensured.

In the structure shown in FIG. 1, the system to render the content data distributed in an encrypted manner reproducible at the user side of the cellular phone requires: 1) the scheme to distribute an encryption key in communication, 2) the scheme itself to encrypt the content data to be distributed, and 3) a configuration realizing content data protection to prevent unauthorized copying of the distributed content data.

The embodiment of the present invention is directed to a structure of providing greater copyright protection on content data by enhancing the authentication and checking function with respect to the transfer destination of content data in respective sessions of distribution and reproduction to prevent output of content data to any recording device and content reproduction apparatus (remote controller) that is not authorized or that has the decryption key violated.

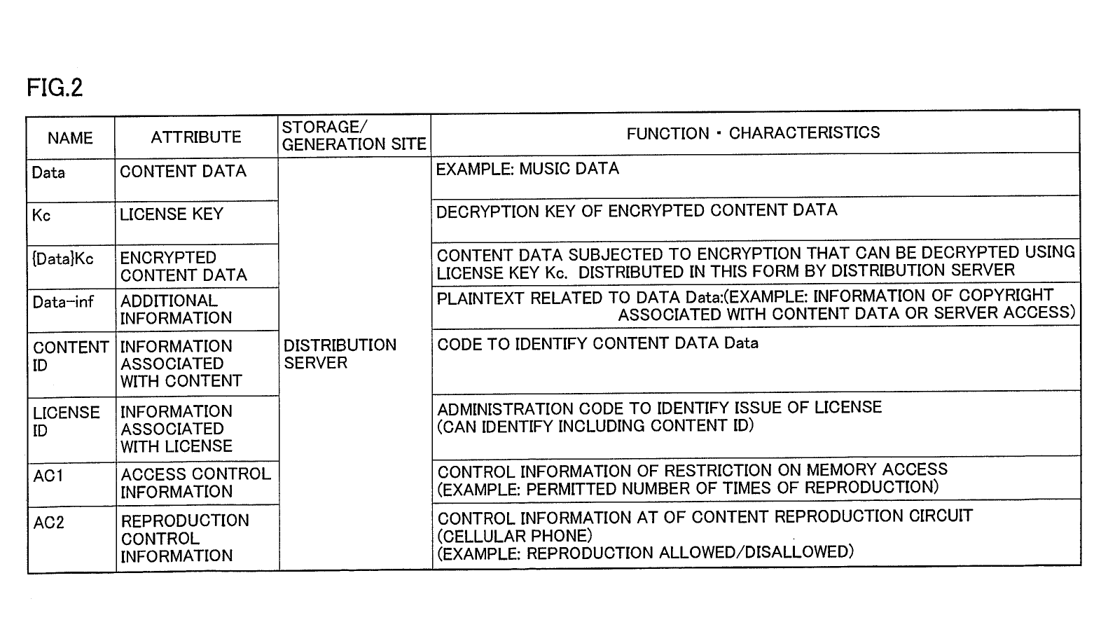

FIG. 2 is a diagram to describe the characteristics of the data and information for communication used in the data distribution system of FIG.

Data distributed by distribution server 30 will be first described. “Data” is content data such as music data. Content data “Data” is encrypted in a form that can be decrypted using a license key Kc. Encrypted content data {Data}Kc encrypted in a manner that can be decrypted by license key Kc is distributed in this form to an appropriate cellular phone user by distribution server 30.

The representation of {Y}X implies that data Y has been encrypted in a form decryptable by decryption key X.

Together with the encrypted content data is distributed additional information Data-inf as plaintext information of the copyright associated with the content data or server access from distribution server 30. The license includes a content ID which is the code to identify content data Data, a license ID that is the control code to identify issue of a license, access control information AC1 associated with restriction as to memory access, reproduction circuit control information AC2 which is the control information of the reproduction circuit, and the like. License key Kc, content ID, license ID, access control information AC1 and reproduction circuit control information AC2 are together generically referred to as “license” hereinafter.

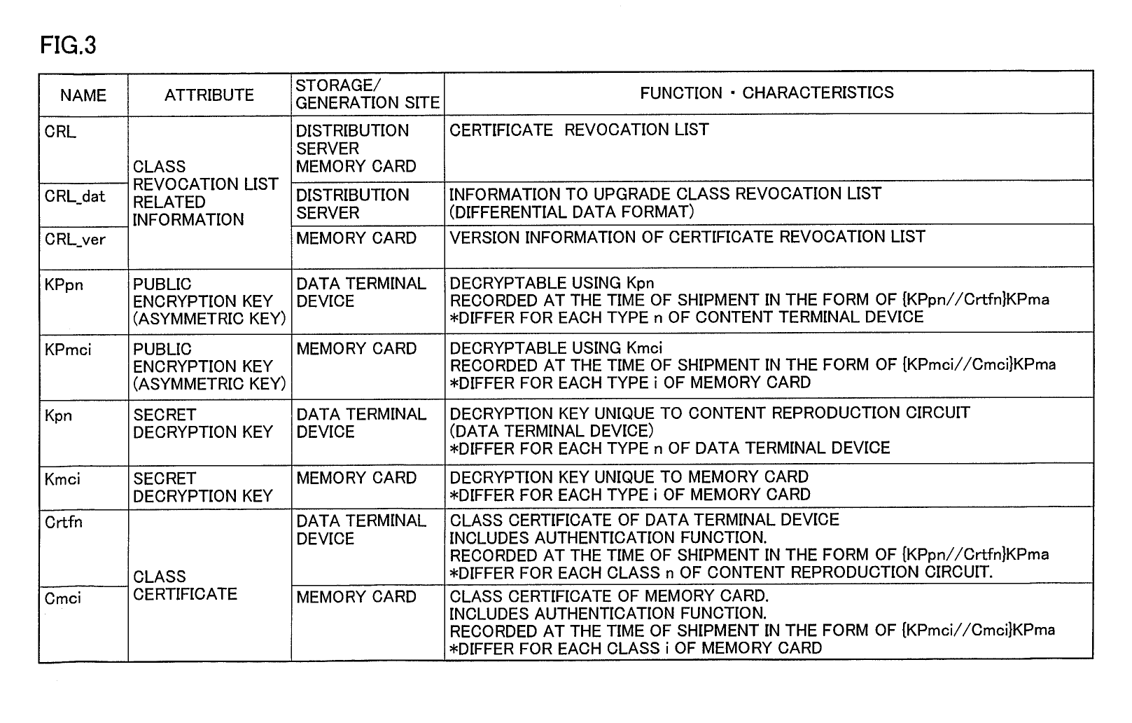

FIG. 3 is a diagram to describe the characteristics of the data and information for operation of an authentication and certificate revocation list employed in the data distribution system of FIG. 1.

In the embodiment of the present invention, a certificate revocation list CRL is employed so as to inhibit distribution and reproduction of content data on a class-by-class basis of the recording device (memory card) and the data terminal device (remote controller) to reproduce content data. The data in the certificate revocation list may be represented by CRL, as necessary, hereinafter.

The certificate revocation list associated information includes certificate revocation list data CRL enumerating the class of data terminal devices and memory cards inhibited of distribution and reproduction of license.

Certificate revocation list data CRL is organized in distribution server 30 and also stored in the memory card. Such a certificate revocation list must be upgraded occasionally to have the data updated. Here, it is assumed that differential data CRL_dat reflecting only modification in data is generated on part of distribution server 30, and certificate revocation list CRL in the memory card is rewritten accordingly. The version of the certificate revocation list is supervised by issuing CRL_ver from the memory card side to be confirmed at the distribution server 30 side. Differential data CRL_dat also includes information as to the new version. It is to be noted that the updated date can be used as the version information.

By retaining and using this certificate revocation list CRL at both the distribution server side and memory card side, any supply of a license key to a data terminal device or memory card whose decryption key unique to the type of the data terminal device and memory card is violated is inhibited. Accordingly, content data cannot be reproduced at the data terminal device whereas the content data cannot be transferred at the memory card.

Thus, certificate revocation list CRL in a memory card is configured to have data updated sequentially at the time of distribution. By storing certificate revocation list CRL in a tamper resistance module in the memory card independent of the upper level, it is possible to prevent certificate revocation list data CRL from being tampered by an upper level through a file system, an application program or the like. Thus, protection on copyrights with respect to data can be further improved.

The data terminal device and memory card are provided with unique public encryption keys KPpn and KPmci. Public encryption keys KPpn and KPmci are decryptable by a private decryption key Kpn unique to the data terminal device and a private decryption key Kmci unique to the memory card, respectively. These public encryption keys and private decryption keys have different values for every type of data terminal device and every type of memory card. These public encryption keys and private decryption keys are generically referred to as “class key”.

The class certificates of Crtfn and Cmci are provided for the reproduction circuit and memory card, respectively. These class certificates have information differing from each class of the memory card and content reproduction unit (remote controller). Any class key corresponding to violated encryption, i.e. any class key whose private decryption key has been illegally obtained, is recorded in the certificate revocation list to become the subject of license issue inhibition.

The public encryption key and class certificate unique to the memory card and content reproduction unit are recorded in the memory card and remote controller of a cellular phone corresponding to a data terminal device at the time of shipment in the form of authentication data {KPmci//Cmci}KPma and {KPpn//Crtfn}KPma, respectively. As will be described in detail afterwards, KPma is a public authentication key common to the entire distribution system.

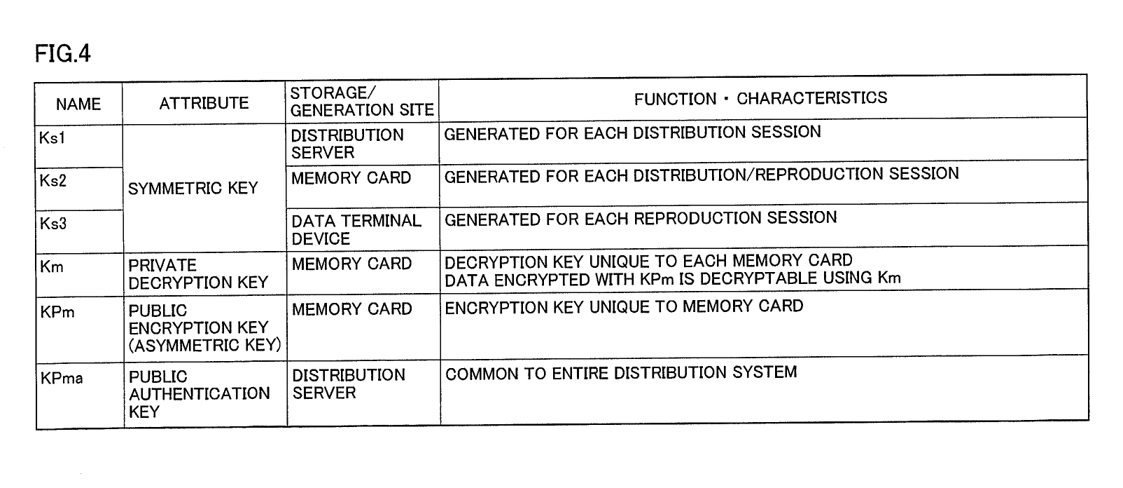

FIG. 4 summarizes the characteristics of the keys associated with encryption in the data distribution system of FIG. 1.

As an encryption key to maintain security in data transfer between a memory card and an external source, symmetric keys Ks1-Ks3 that are generated at the distribution server, data terminal device, and memory card, respectively, at every distribution and reproduction content data, are employed.

Symmetric keys Ks1-Ks3 are unique keys generated for each “session” which is the communication unit or access unit among distribution server 30, data terminal device 120 and memory card 110. These symmetric keys Ks1-Ks3 are also referred to as “session key” hereinafter.

These session keys Ks1-Ks3 are supervised by distribution server 30, data terminal device 120 and memory card 110 by having a unique value for each communication session. Specifically, session key Ks1 is generated for each distribution session by distribution server 30. Session key Ks2 is generated for each distribution session and reproduction session by memory card 110. Session key Ks3 is generated for each reproduction session by data terminal device 120. By transferring these session keys at each session to receive a session key generated at another apparatus, which is used for encryption, followed by transmission of a license key, the security during the session can be improved.

The key to control data processing in memory card 110 includes a public encryption key KPm set for each medium such as memory cards, and a private decryption key Km used to decrypt data encrypted with public encryption key KPm, and that is unique to each memory card.

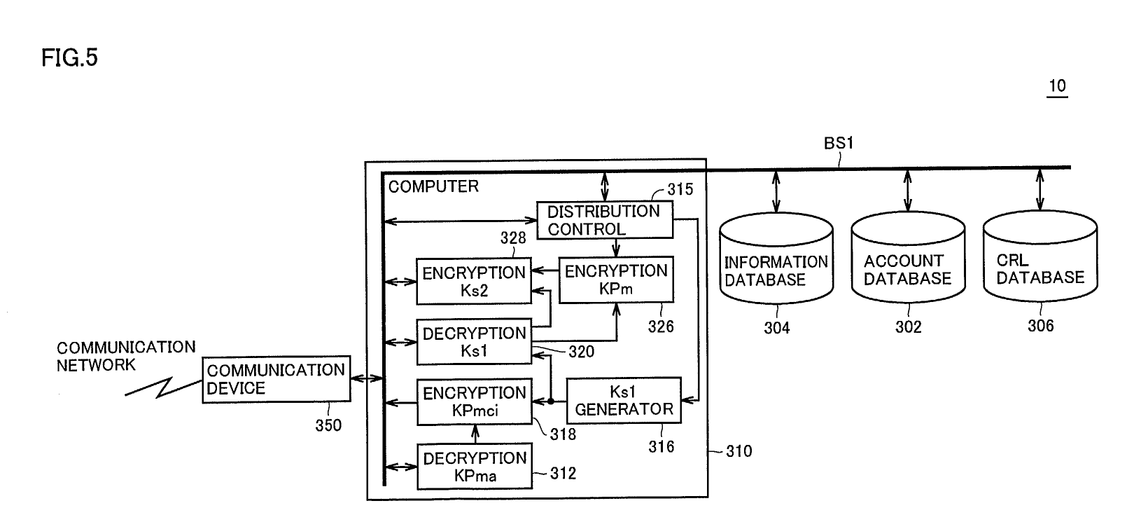

FIG. 5 is a schematic block diagram of a structure of license server 10 of FIG. 1.

License server 10 includes an information database 304 to store encrypted data which is an encrypted version of content data according to a predetermined scheme, as well as distribution information such as a license ID, an account database 302 to store accounting information according to initiating access to content data for each cellular phone user, a CRL database 306 storing certificate revocation list CRL, a data processing unit 310 receiving data from information database 304, account database 302 and CRL database 306 through a data bus BS1 to apply a predetermined process, and a communication device 350 to transfer data between distribution carrier 20 and data processing unit 310 through a communication network.

Data processing unit 310 includes a distribution control unit 315 to control the operation of data processing unit 310 according to data on data bus BS1, a session key generator 316 to generate a session key Ks1 in a distribution session under control of distribution control unit 315, a decryption processing unit 312 receiving authentication data {KPmci//Cmci}KPma for authentication from memory card 110 and data terminal device 120 via communication device 350 and data bus BS1 to carry out a decryption process through public authentication key KPma, an encryption processing unit 318 encrypting session key Ks1 generated by session key generation unit 316 using public encryption key KPmci obtained by decryption processing unit 312 to output the encrypted key onto data bus BS1, and a decryption processing unit 320 receiving data through data bus BS1 transmitted in an encrypted form using session key Ks1 to apply a decryption process.

Data processing unit 310 further includes an encryption processing unit 326 to encrypt license key Kc and reproduction circuit control information AC2 applied from distribution control unit 315 using a public encryption key KPm unique to a memory card from decryption processing unit 320, and an encryption processing unit 328 to further encrypt the output of encryption processing unit 326 using a session key Ks2 applied from decryption processing unit 320 to provide the encrypted data onto data bus BS1.

The operation of license server 10 in a distribution session will be described in detail afterwards with reference to a flow chart.

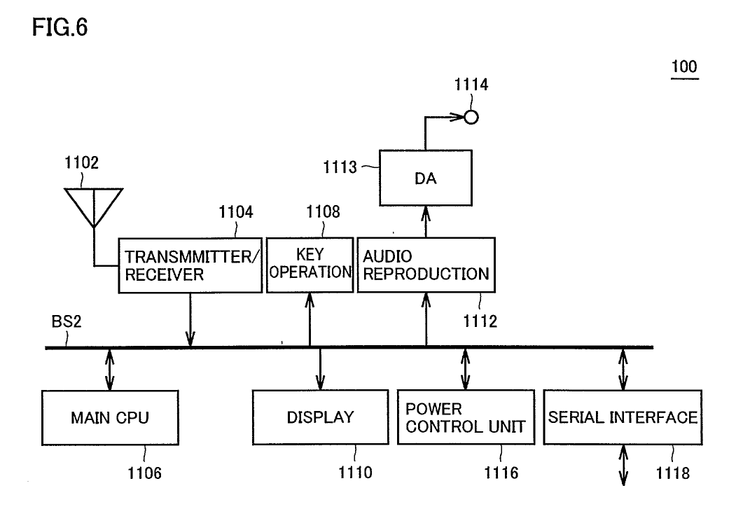

FIG. 6 is a schematic block diagram to describe the structure of cellular phone 100 of FIG. 1.

Cellular phone 100 includes an antenna 1102 to receive signals transmitted through radio by a cellular phone network, a transmitter/receiver unit 1104 converting received signals from antenna 1102 into base band signals, or modulating and providing to antenna 1102 data from a cellular phone, a data bus BS2 to transfer data among the components in cellular phone 100, and a main CPU 1106 to control the operation of cellular phone 100 via a data bus BS2.

Cellular phone 100 further includes a key operation unit 1108 to apply an external instruction to cellular phone 100, a display 1110 to provide information output from main CPU 1106 and the like to the cellular phone user as visual information, and an audio reproduction unit 1112 to reproduce audio based on reception data applied via data bus BS2 in a general conversation operation.

Cellular phone 100 further includes a DA converter 1113 converting the digital signal output from audio reproduction unit 1112 into an analog signal, and a terminal 1114 to provide the output of DA converter 1113 to an external output device or the like.

Cellular phone 100 further includes a serial interface 1118 to transfer data with remote controller 120.

Cellular phone 100 further includes a power control unit 1116 to supply power to antenna 1102, transmitter/receiver unit 1104, main CPU 1106, key operation unit 1108, display 1110, audio reproduction unit 1112, DA converter 1113 and serial interface 1118.

For the sake of simplification, only the block associated with distribution and reproduction of audio data of a cellular phone is illustrated in FIG. 6, and some of the blocks related to the conversation function inherent to a cellular phone are omitted.

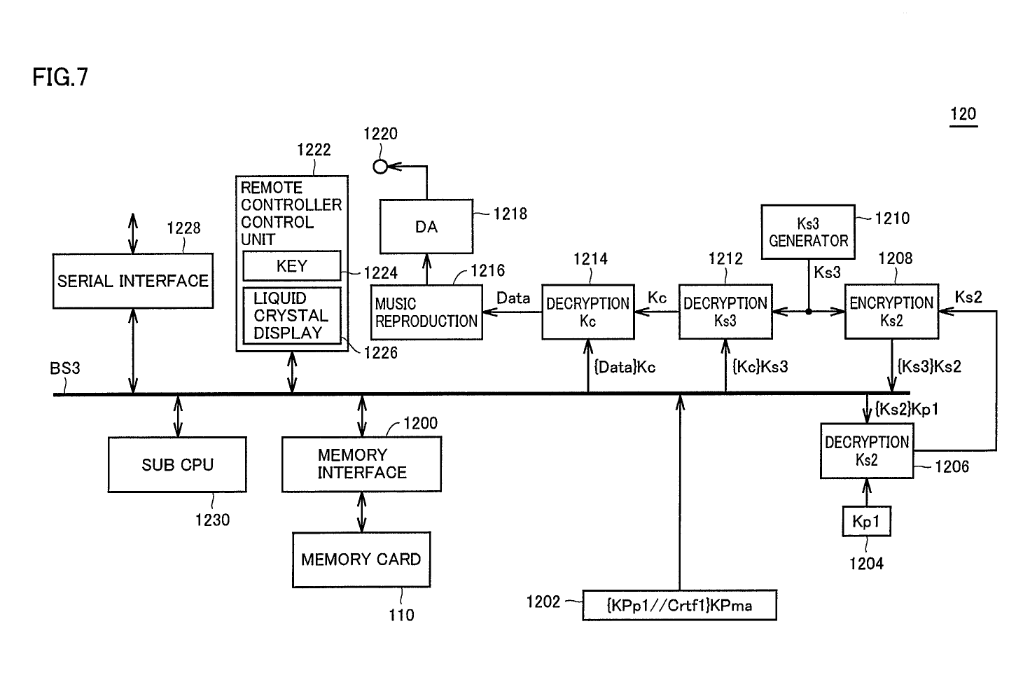

FIG. 7 is a schematic block diagram of a remote controller (data terminal device) 120 of FIG. 1. Remote controller 120 includes a detachable memory card 110 to store and apply a decryption process on content data (music data) from distribution server 30, and a memory interface 1200 to control data transfer between memory card 110 and a data bus BS3.

A public encryption key KPpn, a private decryption key Kpn and a class certificate Crtfn unique to the remote controller corresponding to the data terminal device are provided, where natural number n is 1 in remote controller 120, as described previously. Therefore, remote controller 120 includes an authentication data hold unit 1202 storing authentication data {KPp1//Crtf1}KPma in a form encrypted so as to have the authenticity verified by decrypting public encryption key KPp 1 and class certificate Crtf1 using public decryption key KPma. Encryption key KPp 1 and class certificate Crtf1 are set for each remote controller type (class).

Remote controller 120 further includes a Kp1 hold unit 1204 storing a decryption key Kp1 unique to remote controller (data terminal device) 120, and a decryption processing unit 1206 decrypting the data received from data bus BS3 using decryption key Kp1 to obtain session key Ks2 generated by memory card 110.

Remote controller 120 further includes a session key generator 1210 generating by a random number or the like a session key Ks3 used to encrypt data transferred on data bus BS3 by memory card 110 in a reproduction session of reproducing the content data stored in memory card 110, and an encryption processing unit 1208 encrypting the generated session key Ks3 using session key Ks2 obtained by decryption processing unit 1206 and providing the encrypted session key onto data bus BS3.

Remote controller 120 further includes a decryption processing unit 1212 to decrypt the data on data bus BS3 using session key Ks3 for output.

Remote controller 120 further includes a decryption processing unit 1214 decrypting encrypted content data {Data}Kc received from data bus BS3 using license key Kc obtained by decryption processing unit 1212 to output content data Data, a music reproduction unit 1216 receiving the output of decryption processing unit 1214 to reproduce content data, a DA converter 1218 to convert the digital signal output from audio reproduction unit 1216 into an analog signal, and a connection terminal 1220 to connect with headphone 130.

Remote controller 120 further includes a remote controller control unit 1222 with a key operation unit 1224 accepting a user's reproduction request, selection of music data recorded in memory card 110 and fast-forward instruction of music data or the like, and a liquid crystal display unit 1226 displaying a list of song titles of the music data recorded in memory card 110, and a serial interface 1228 to transfer data with cellular phone 100. Although remote controller 120 is described to be connected to respective structural elements such as sub CPU 1230 via data bus BS3, each component may be connected to each other through a plurality of buses, or connected to each other without the data bus.

The operation of each component of cellular phone 100 and remote controller 120 in respective sessions will be described in detailed afterwards with reference to a flow chart.

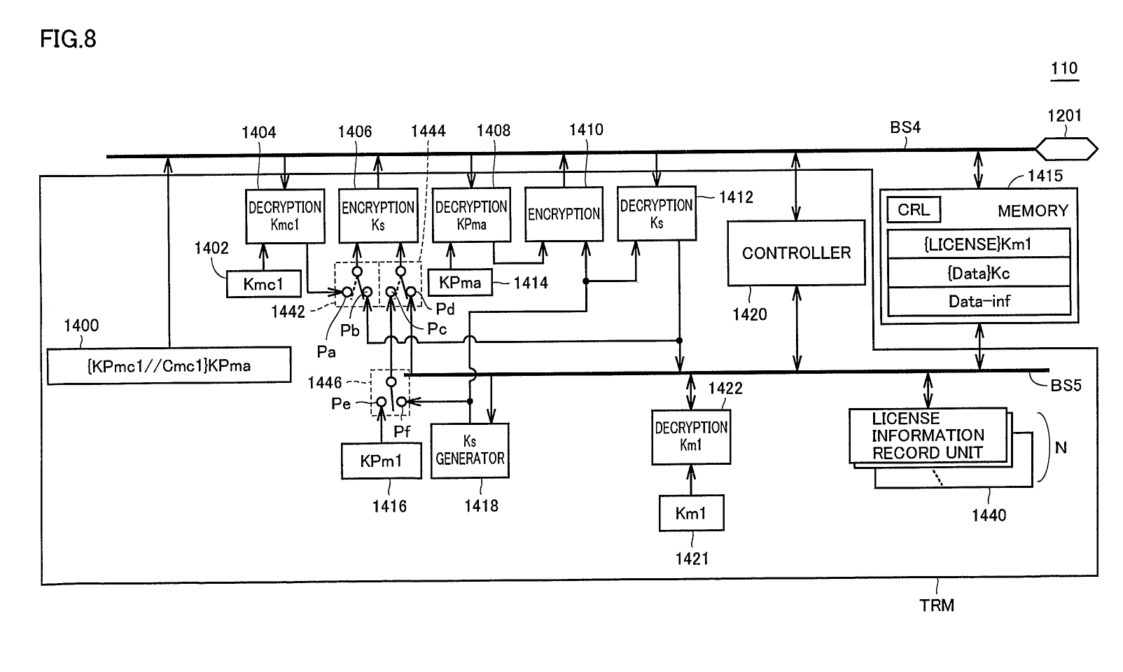

FIG. 8 is a schematic block diagram of a structure of memory card 110.

As mentioned before, public encryption key KPmci and private decryption key Kmci are provided unique to the memory card with a memory card class certificate Cmci. It is assumed that these are respectively represented by natural number i=1 in memory card 110.

Accordingly, memory card 110 includes an authentication data hold unit 1400 storing authentication data {KPmc1//Cmc1}KPma, a Kmc1 hold unit 1402 storing a decryption key Kmc1 set unique to each memory card type, a Km1 hold unit 1421 storing a private decryption key Km1 set unique to each memory card, and a KPm1 hold unit 1416 storing a public encryption key KPm1 that is decryptable by private decryption key Km1. Authentication data hold unit 1400 stores authentication data {KPmc1//Cmc1}KPma encrypted in a form that an have the authenticity verified by decrypting secret encryption key KPmc1 and class certificate Cmc1 set for each memory card type and class using public authentication key KPma.

By providing an encryption key for the record device corresponding to a memory card, the distributed content data and encrypted license key can be controlled in the memory card unit as will become apparent from the following description.

Memory card 110 further includes a data bus BS4 transferring data with memory interface 1200 via a terminal 1201, a decryption processing unit 1404 receiving from Kmc1 hold unit 1402 a private decryption key Kmc1 unique to each memory card type, decrypting the data applied onto data bus BS4 from memory interface 1200 with private decryption key Kmc1, and providing session key Ks1 generated by distribution server 30 in a distribution session to a contact Pa, a decryption processing unit 1408 receiving an authentication key KPma from KPma hold unit 1414 which is used to apply a decryption process on the data applied on data bus BS4 and providing the decrypted result to encryption processing unit 1410, and an encryption processing unit 1406 encrypting data selectively applied by switch 1444 using a key selectively applied by switch 1442 to provide the encrypted data onto a data bus BS4.

Memory card 110 further includes a session key generator 1418 generating a session key Ks2 at respective sessions of distribution and reproduction, an encryption processing unit 1410 encrypting session key Ks2 output from session key generation unit 1418 using public encryption key KPpn or KPmci obtained by decryption processing unit 1408 to transmit the encrypted key onto data bus BS4, and a decryption processing unit 1412 receiving data encrypted with session key Ks2 from data bus BS4 and decrypt the received data using session key Ks2 from session key generation unit 1418 to send the decrypted result onto a data bus BS5.

Memory card 110 further includes a decryption processing unit 1422 decrypting the data on data bus BS4 using a private decryption key KPm1 companion to public encryption key KPm1 and unique to memory card 110, and a memory 1415 receiving and storing from data bus BS5 license key Kc encrypted with public encryption key KPm1, reproduction circuit control information AC2, content ID, license ID, access control information AC1, and certificate revocation list data CRL sequentially updated by differential data CRL_dat for the upgrade of the certificate revocation list that is not encrypted as well as receiving and storing from data bus BS4 encrypted content data {Data}Kc and additional information Data-inf Memory 1415 is configured by, for example, a semiconductor memory device.

Memory card 110 further includes a license informtion recording table 1440 to store a license ID obtained by decryption processing unit 1422, content ID and access control information AC1, and a controller 1420 transferring data with an external source via data bus BS4 and receiving access control information AC1 or the like from data bus BS5 to control the operation of memory card 110.

License informtion recording table 1440 can transfer data of the license ID, content ID and access control information AC1 with data bus BS5. License informtion recording table 1440 includes N (N: natural number) banks. Each license is stored for each bank.

It is to be noted that the region enclosed by the solid line in FIG. 8 is incorporated in a module TRM to disable readout by a third party of data and the like in the circuitry residing in this region by erasing the internal data or destroying the internal circuitry at an attempt of an improper opening process or the like by an external source. Such a module is generally a tamper resistance module.

A structure may be implemented wherein memory 1415 is also incorporated in module TRM. However since the data stored in memory 1415 is completely encrypted according to the structure shown in FIG. 8, a third party will not be able to reproduce the music with just the data in this memory 1415. It is not necessary to provide memory 1415 in the expensive tamper resistance module. Thus, there is an advantage that the fabrication cost is reduced.

The operation of the data distribution system of FIG. 1 in respective sessions will be described in detail hereinafter with reference to a flow chart.

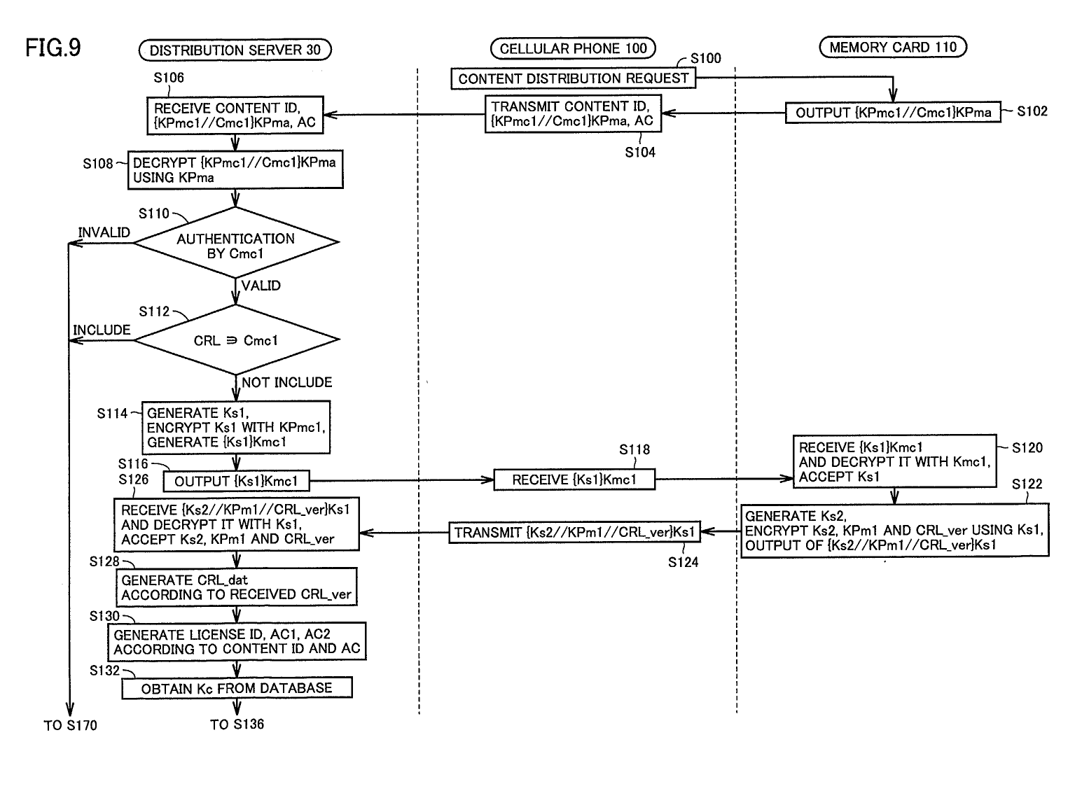

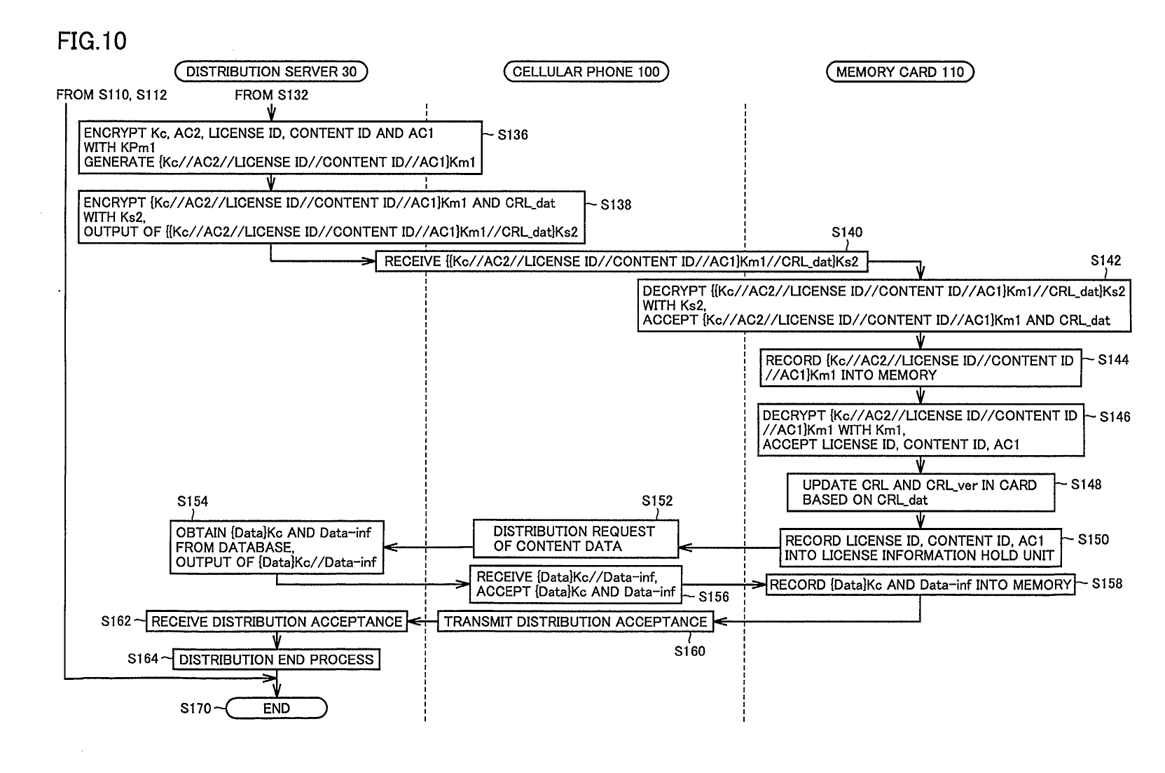

FIGS. 9 and 10 are the first and second flow charts, respectively, to describe the distribution operation occurring in purchasing content data (also called “distribution session” hereinafter) in the data distribution system of FIG. 1.

FIGS. 9 and 10 correspond to the operation of the cellular phone user receiving distribution of content data which is music data from distribution server 30 through remote controller 120 and cellular phone 100 by using memory card 110. Since remote controller 120 is absent of the function to communicate with distribution server 30 although a key operation unit 1224 is incorporated in remote controller 120, a content data request is issued to distribution server 30 using cellular phone 100.

First, a distribution request is issued from the user's cellular phone 100 through operation of the key button on key operation unit 1108 by the user (step S100).

In response, main CPU 1106 of cellular phone 100 notifies the issue of a distribution request via serial interface 1118. Sub CPU 1230 of remote controller 120 receives the distribution request via serial interface 1228 to issue the distribution request to memory card 110 via memory interface 1200. At memory card 110, authentication data {KPmc1//Cmc1}KPma from authentication data hold unit 1400 is output in response to the distribution request (step S102).

Remote controller 120 sends the accepted authentication data {KPmc1//Cmc1}KPma from memory card 110 to cellular phone 100 via serial interface 1228. Cellular phone 100 transmits to distribution server 30 the content ID and license purchase condition data AC together with the authentication data {KPmc1//Cmc1}KPma from memory card 110 (step S104).

At distribution server 30, the content ID, authentication data {KPmc1//Cmc1}KPma, and license purchase condition AC are received from cellular phone 100 (step S106). Decryption processing unit 312 decrypts the authentication data output from memory card 110 using public authentication key KPma (step S108).

Distribution control unit 315 determines whether the authentication has been carried out properly from the decryption processing result of decryption processing unit 312, i.e. performs an authentication process of determining whether authentication data subjected to encryption to verify the authenticity by a proper authority has been received or not in order to conduct authentication of memory card 110 retaining a public encryption key KPmc1 and certificate Cmc1 from a legal memory card (step S110). When determination is made of the legal authentication data, distribution control unit 315 acknowledges and accepts public encryption key KPmc1 and certificate Cmc1. Then, control proceeds to the next process (step S112). When the authentication data is not proper, the data is unproved and the process ends without accepting public encryption key KPmc1 and certificate Cmc1 (step S170).

When the authenticity of the proper apparatus is verified as a result of authentication, distribution control unit 315 refers to CRL database 306 to check whether class certificate Cmc1 of memory card 110 is recorded in certificate revocation list CRL. When the class certificate is included in the certificate revocation list, the distribution session ends at this stage (step S170).

When the class certificate of memory card 110 is not on the certificate revocation list, control proceeds to the next process (step S112).

Upon confirming that the access is from a remote controller and cellular phone that has a memory card with legal authentication data and that the class is not on the certificate revocation list, session key generation unit 316 of distribution server 30 generates a session key Ks1 for distribution. Session key Ks1 is encrypted by encryption processing unit 318 using public encryption key KPmc1 corresponding to memory card 110 from decryption processing unit 312 (step S114).

Encrypted session key Ks1 is output via data bus BS1 and communication device 350 as encrypted data {Ks1}Kmc1 (step S116).

Following reception of encrypted session {Ks1}Kmc1 by cellular phone 100 (step S118), encrypted session key {Ks1}Kmc1 is output via serial interface 1118 to memory card 110 through remote controller 120. In memory card 110, the reception data applied onto data bus BS4 via memory interface 1200 is decrypted by decryption processing unit 1404 using private decryption key Kmc1 unique to memory card 110 stored in Kmc1 hold unit 1402, whereby session key Ks1 is decrypted and extracted (step S120).

Upon confirming acceptance of session key Ks1 generated at distribution server 30, controller 1420 instructs session key generation unit 1418 to generate a session key Ks2 that is generated in a distribution operation at memory card 110.

In the distribution session, controller 1420 extracts from memory 1415 the list of version data CRL_ver as information associated with the status (version) of the certificate revocation list stored in memory 1415 in memory card 110. The extracted data is output onto data bus BS5.

Encryption processing unit 1406 encrypts session key Ks2, public encryption key KPm 1 and version data CRL_ver of the certificate revocation list applied by sequentially switching the contacts of switches 1444 and 1446 as one data sequence using session key Ks1 applied from decryption processing unit 1406 via contact Pa of switch 1442 to provide the encrypted data {Ks2//KPm1//CRL_ver}Ks1 onto data bus BS4 (step S122).

Encrypted data {Ks2//KPm1//CRL_ver}Ks1 output onto data bus BS4 is provided to remote controller 120 via terminal 1201 and memory interface 1200 to be further provided to cellular phone 100 via serial interface 1228, and then transmitted to distribution server 30 (step S124).

Distribution server 30 receives encrypted data {Ks2//KPm1//CRL_ver}Ks1, which is subjected to a decryption process at decryption processing unit 320 using session key Ks1. Thus, session key Ks2 generated at memory card 110, public encryption key KPm1 unique to memory card 110, and version data CRL_ver of the certificate revocation list of memory card 110 are accepted (step S126).

Version information CRL_ver of the certificate revocation list is transmitted to distribution control unit 315 via data bus BS1. Distribution control unit 315 generates differential data CRL_dat that represents the change between the version of the relevant received version data CRL_ver and the current version of the certificate revocation list data in CRL database 306 (step S128).

Distribution control unit 315 also generates a license ID, access control information AC1 and reproduction circuit control information AC2 according to the content ID and license purchase condition AC obtained at step S106 (step S130). Also, a license key Kc used to decrypt encrypted content data is obtained from information database 304 (step S132).

Referring to FIG. 10, distribution control unit 315 provides to encryption processing unit 326 the generated license, i.e. license key Kc, reproduction circuit control information AC2, the license ID, content ID and access control information AC1. Encryption processing unit 326 encrypts the license using public encryption key KPm 1 unique to memory card 110 obtained from decryption processing unit 320 (step S136). Encryption processing unit 328 receives the output of encryption processing unit 326 and differential data CRL_dat of the certificate revocation list supplied from distribution control unit 315 via data bus BS 1 and applies an encryption process thereon using session key Ks2 generated by memory card 110. The encrypted data output from encryption processing unit 328 is transmitted to cellular phone 100 via data bus BS1 and communication device 350 (step S138).

By transferring respective encryption keys generated at the distribution server and memory card to each other to execute encryption using respective received encryption keys and transmitting the decrypted data to the other party, authentication of each other can be virtually conducted in the transmission/reception of respective encrypted data. Thus, the security of the data distribution system can be improved.

Cellular phone 100 receives the transmitted encrypted data {{Kc//AC2//license ID//content ID//AC1}Km1//CRL_dat}Ks₂ (step S140), and provides the same to remote controller 120 via serial interface 1118. Remote controller 120 provides the encrypted data {{Kc//AC2//license ID//content ID//AC1}Km1//CRL_dat}Ks2 to memory card 110 via memory interface 1200. In memory card 110, the received data applied on data bus BS4 is decrypted by decryption processing unit 1412 through memory interface 1200. Decryption processing unit 1412 decrypts the data on data bus BS4 using session key Ks2 applied from session key generation unit 1418 to provide the decrypted data onto data bus BS5 (step S142).

At this stage, encrypted license {Kc//AC2//license ID//content ID//AC1}Km1 that is decryptable using private decryption key Km1 stored in Km1 hold unit 1421 as well as data CRL_dat are output on data bus BS5. In response to an instruction from controller 1420, encrypted license {Kc//AC2//license ID//content ID//AC1}Km1 is stored in memory 1415 (step S144). The encrypted license {Kc//AC2//license ID//content ID//AC1}Km1 is decrypted at decryption processing unit 1422 using private decryption key Km1. Only the license ID, content ID and access control information AC1 referred to in memory card 110 are accepted out of the license (step S 146).

Controller 1420 updates certificate revocation list data CRL and the version thereof in memory 1415 based on the accepted data CRL_dat (step S148). The license ID, content ID and access control information AC1 are stored in license informtion recording table 1440 (step S150).

At the stage where the process up to step S150 has ended properly in the memory, cellular phone 100 issues a content data distribution request to distribution server 30 (step S152).

In response to this content data distribution request, distribution server 30 obtains encrypted content data {Data}Kc and additional data Data-inf from information database 304. The obtained data are output via data bus BS1 and communication device 350 (step S154).

Cellular phone 100 receives {Data}Kc//Data-inf, and accepts encrypted content data {Data}Kc and additional information Data-inf (step S156). Encrypted content data {Data}Kc and additional information Data-inf pass through serial interface 1118, serial interface 1228 of remote controller 120, memory interface 1200 and terminal 1201 to be transmitted onto data bus BS4 of memory card 110. At memory card 110, the received encrypted content data {Data}Kc and additional information Data-inf are directly stored in memory 1415 (step S158).

Then, a distribution acceptance notification is transmitted from memory card 110 to distribution server 30 (step S160). In response to reception of distribution acceptance at distribution server 30 (step S162), the distribution end process is executed with storage of accounting data into accounting database 302 (step S164), and the entire process ends (step S170).

Upon confirming that memory card 110 loaded in remote controller 120 of cellular phone 100 is a legal apparatus and that public encryption key KPmc1 transmitted in an encrypted form together with class certificate Kmc1 are valid, content data can be distributed with respect to only a distribution request from a memory card that does not have a class certificate Cmc1 recorded in the certificate revocation list, i.e. a class certificate whose encryption by public encryption keys Kp 1 and Kmc1 is violated, in other words, the companion private decryption key Kmc1 is uncovered. Thus, distribution to an illegal memory card or distribution using an unscrambled class key can be inhibited.

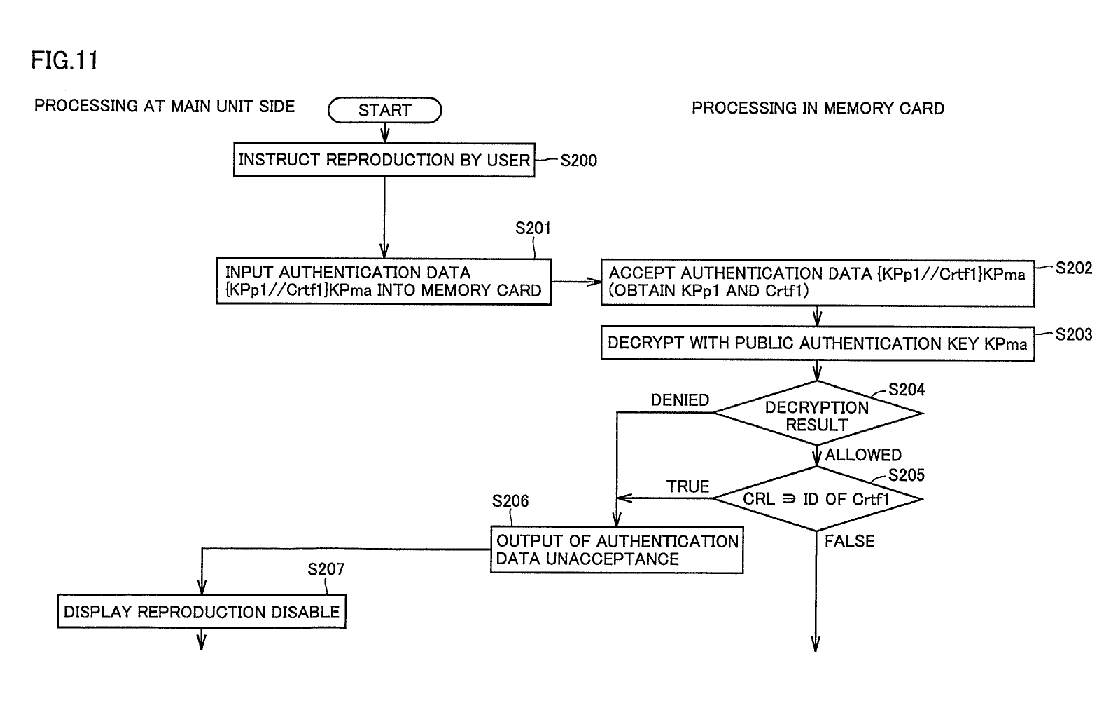

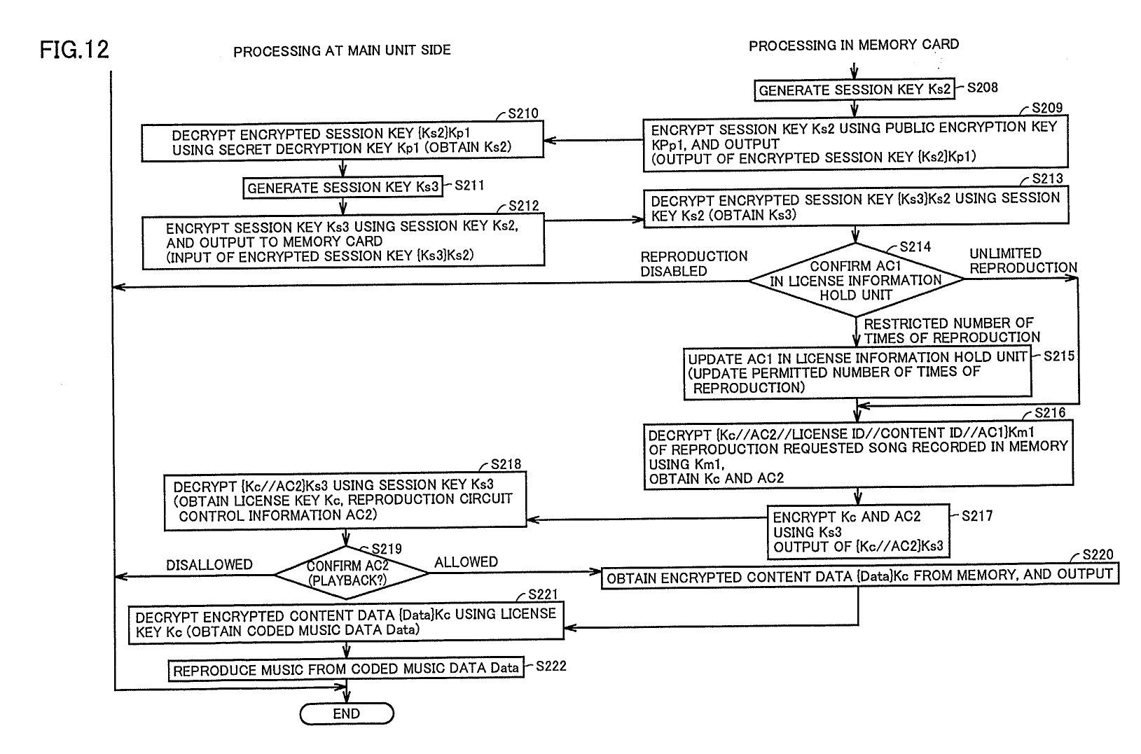

The reproduction operation by remote controller 120 of the content data distributed to memory card 110 will be described with reference to FIGS. 11 and 12. At the start of a reproduction operation, a reproduction command is input to remote controller 120 by the user of cellular phone 100 through key operation unit 1108 or 1224 (step S200). In response, sub CPU 1230 reads out authentication data {KPp 1//Crtf1}KPma from authentication data hold unit 1202 via data bus BS3 and applies authentication data {KPp 1//Crtf1}KPma to memory card 110 via memory interface 1200 (step S201).

Accordingly, memory card 110 accepts authentication data {KPp 1//Crtf1}KPma (step S202). Decryption processing unit 1408 of memory card 110 decrypts the accepted authentication data {KPp 1//Crtf1}KPma using public authentication key KPma stored in KPma hold unit 1414 (step S203). Controller 1420 conducts an authentication process from the decryption processed result of decryption processing unit 1408. Specifically, an authentication process of determining whether authentication data {KPp 1//Crtf1}KPma is the proper authentication data is carried out (step S204). In the case where decryption cannot be realized, controller 1420 provides an authentication data unaccepted output to memory interface 1200 of remote controller 120 via data bus BS4 and terminal 1201 (step S206). In the case where the authentication data can be decrypted, controller 1420 determines whether the obtained certificate Crtf1 is included in the certificate revocation list data read out from memory 1415 (step S205). In this case, certificate Crtf1 is assigned an identification information. Controller 1420 determines whether the identification information of the received certificate Crtf1 is present in the certificate revocation list data. When determination is made that certificate Crtf1 is recorded in the certificate revocation list data, controller 1420 provides the authentication data unaccepted output to memory interface 1200 of remote controller 120 via data bus BS4 and terminal 1201 (step S206).

An authentication data unaccepted output is issued in the case where the authentication data cannot be decrypted using public encryption key KPma at step S204 or when the received certificate Crtf1 is found in the certificate revocation list data at step S205. Upon receiving the authentication data unaccepted output via memory interface 1200, sub CPU 1230 of remote controller 120 notifies cellular phone 100 that reproduction is disabled via serial interface 1228, and provides a display at liquid crystal display 1266 of remote controller unit 1220 indicating that reproduction is disabled (step S207). Main CPU 1106 of cellular phone 100 receives the authentication data unaccepted notification and provides on display 110 a display indicating that reproduction is disabled (step S207). When the authentication data unaccepted notification is issued at step S206, the reproduction operation can be terminated instead of providing a display indicating that reproduction is disabled.

When determination is made that certificate Crtf1 is not included in the certificate revocation list data at step S205, control proceeds to step S208 shown in FIG. 12. Session key generation unit 1418 of memory card 110 generates session key Ks2 for a reproduction session (step S208). Encryption processing unit 1410 encrypts session key Ks2 from session key generation unit 1418 using public encryption key KPp 1 decrypted at decryption processing unit 1408. Encrypted data {Ks2}Kp 1 is output onto data bus BS4 (step S209). Then, controller 1420 provides encrypted data {Ks2}Kp1 to memory interface 1200 via terminal 1201. Sub CPU 1230 of remote controller 120 obtains encrypted data {Ks2}Kp 1 via memory interface 1200. Kp1 hold unit 1204 provides private decryption key Kp1 to decryption processing unit 1206.

Decryption processing unit 1206 decrypts encrypted data {Ks2}Kp 1 using private decryption key Kp 1 output from Kp 1 hold unit 1204 and companion to public encryption key KPp1. Session key Ks2 is provided to encryption processing unit 1208 (step S210). Then, session key generation unit 1210 generates a session key Ks3 for a reproduction session. Session key Ks3 is provided to encryption processing unit 1208 (step S211). Encryption processing unit 1208 encrypts session key Ks3 from session key generation unit 1210 using session key Ks2 from decryption processing unit 1206 to output encrypted data {Ks3}Ks2. Sub CPU 1230 provides encrypted data {Ks3}Ks2 via data bus BS3 and memory interface 1200 to memory card 110 (step S212).

Decryption processing unit 1412 of memory card 110 receives encrypted data {Ks3}Ks2 via terminal 1201 and data bus BS4 to decrypt the same using session key Ks2 generated by session key generation unit 1418 to obtain session key Ks3 generated at remote controller 120 (step S213).

According to acceptance of session key Ks3, controller 1420 confirms corresponding access control information AC1 in license informtion recording table 1440 (step S214).

By confirming access control information AC1 that is information associated with restriction as to memory access at step S214, the reproduction operation ends in the case where reproduction is already disabled, or updates the data of access control information AC1 to alter the permitted number of times of reproduction in the case where the reproducible number of times is restricted (step S215). In the case where the number of times of reproduction is not restricted by access control information AC1, control skips step S215 to proceed to the next step (step S216) without having access control information AC1 updated.

Determination is made that reproduction is disabled also in the case where the relevant content ID of the requested song is not present in license informtion recording table 1440. Accordingly, the reproduction operation is terminated.

When determination is made that the relevant reproduction operation is allowed at step S214, a decryption process is executed on the license including license key Kc of the requested music to be reproduced, stored in the memory. Specifically, in response to a command from controller 1420, decryption processing unit 1422 decrypts encrypted license {Kc//AC2//license ID//content ID//AC1}Km1 read out from memory 1415 onto data bus BS5 using private decryption key Km1 unique to memory card 110, whereby license key Kc and reproduction circuit control information AC2 required for the reproduction process are provided on data bus BS5 (step S216).

The obtained license key Kc and reproduction circuit control information AC2 are transmitted to encryption processing unit 1406 via contact Pd of switch 1444. Encryption processing unit 1406 encrypts license key Kc and reproduction circuit control information AC2 received from data bus BS5 using session key Ks3 received from decryption processing unit 1412 via contact Pd of switch 1442, whereby encrypted data {Kc//AC2}Ks3 is output onto data bus BS4 (step S217).

Encrypted data {Kc//AC2}Ks3 on data bus BS4 is transmitted to remote controller 120 via memory interface 1200.

At remote controller 120, decryption processing unit 1212 decrypts encrypted data {Kc//AC2}Ks3 transmitted on data bus BS3 via memory interface 1200 to accept license key Kc and reproduction circuit control information AC2 (step S218). Decryption processing unit 1212 transmits license key Kc to decryption processing unit 1214 and reproduction circuit control information AC2 onto data bus BS3.

Sub CPU 1230 accepts reproduction circuit control information AC2 via data bus BS3 to confirm whether reproduction is allowed or not (step S219).

When determination is made that reproduction is disallowed through reproduction circuit control information AC2 at step S219, the reproduction operation is terminated.

When determination is made that reproduction is allowed at step S219, sub CPU 1230 requests memory card 110 for encrypted content data 15. {Data}Kc via memory interface 1200. Accordingly, controller 1420 of memory card 110 obtains encrypted content data {Data}Kc from memory 1415 and provides the obtained encrypted data {Data}Kc to memory interface 1200 via data bus BS4 and terminal 1201 (step S220).

Sub CPU 1230 of remote controller 120 obtains encrypted content data {Data}Kc via memory interface 1200. Encrypted content data {Data}Kc is applied to decryption processing unit 1214 via data bus BS3.

Decryption processing unit 1214 decrypts encrypted content data {Data}Kc using license key Kc output from decryption processing unit 1212 to obtain content data Data (step S221).

The obtained content data Data is provided to music reproduction unit 1216. Music reproduction unit 1216 reproduces the content data. DA converter 1218 converts the digital signal into an analog signal, which is provided to terminal 1220. Then, the music data is provided to headphone 130 via terminal 1220 to be reproduced (step S222). Thus, the reproduction operation ends.

Remote controller 120 of FIG. 7 is supplied with the driving power from cellular phone 100 of FIG. 6. In this case, serial interface 1118 of cellular phone 100 supplies the driving power from power control unit 1116 to remote controller 120 through a cable or the like. Remote controller 120 is driven by the driving source supplied from cellular phone 100 to transmit content data to memory card 110 in the distribution operation and reproduces the content data from memory card 110.

Since cellular phone 100 includes a main CPU 1106 and remote controller 120 includes a sub CPU 1230, the user can reproduce the content data from memory card 110 by remote controller 120 after the content data is distributed to memory card 110. The user can conduct mail transmission and the like using cellular phone 100 while listening to the music through headphone 130.

After the content data is distributed to memory card 110, sub CPU 1230 of remote controller 120 exclusively carries out the reproduction operation of the content data. In other words, sub CPU 1230 can produce a list of the song titles of the content data recorded in memory card 110 to display the song list on liquid crystal display 1226 of remote controller unit 1222 as well as initiating a reproduction operation in response to a reproduction request through key operation unit 1224 of remote controller control unit 1222.

A reproduction request can be input through key operation unit 1108 of cellular phone 100. In response to a reproduction request through key operation unit 1108, main CPU 1106 transmits the reproduction request to remote controller 120 via serial interface 1118. Sub CPU 1230 of remote controller 120 receives the reproduction request via serial interface 1228 to initiate a reproduction operation.

Thus, cellular phone 100 per se hardly functions in the operation of reproducing the content data recorded in memory card 110. Therefore, cellular phone 100 can be used for mail communication and the like even if remote controller 120 is reproducing content data.

Although the above embodiment was described in which remote controller 120 of FIG. 7 is absent of a driving power, remote controller 120 may include its own driving power. In this case, the cable required to transfer data between cellular phone 100 and remote controller 120 is dispensable. Data can be transferred through radio. Therefore, in distributing content data, the encrypted content data and license key transmitted from distribution server 30 to cellular phone 100 are sent from cellular phone 100 to remote controller 120 through radio to be recorded in memory card 110.

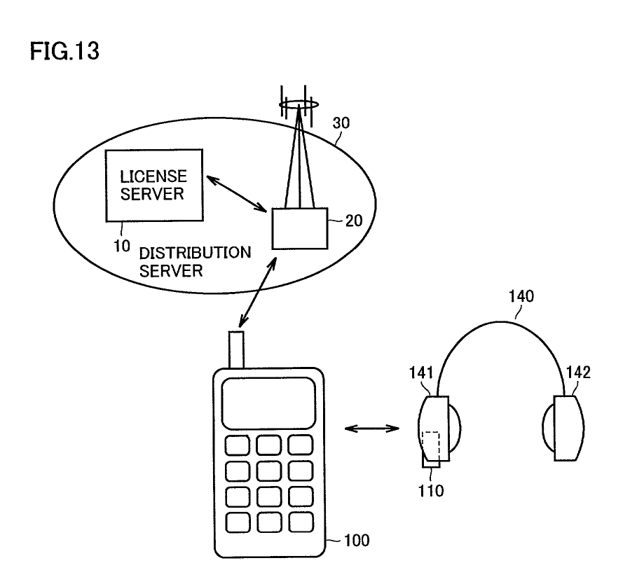

When data is transferred between remote controller 120 and cellular phone 100 through radio, the distribution system as shown in FIG. 13 is particularly preferable. In the distribution system of FIG. 13, data transfer between cellular phone 100 and headphone 140 is effected through radio. In this case, memory card 110 is loaded in one speaker unit 141 of the two speaker units of headphone 140.

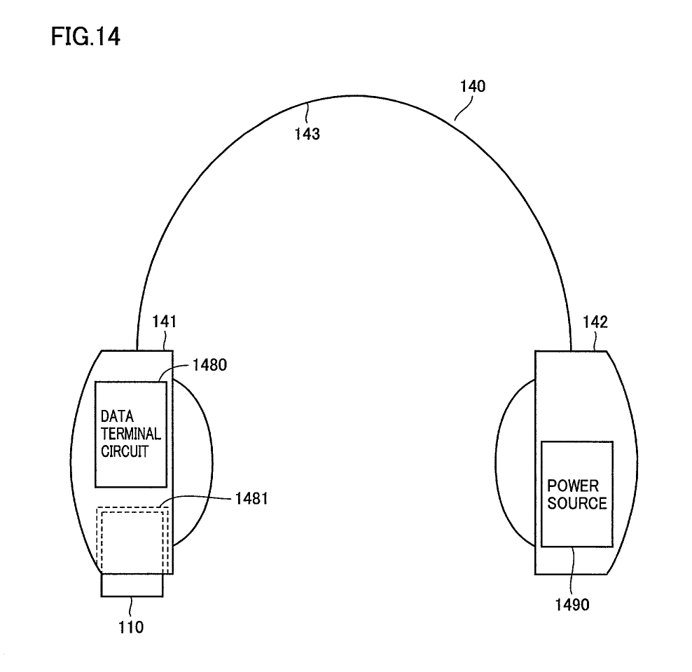

Referring to FIG. 14, speaker unit 141 is connected to speaker unit 142 through a support member 143. Speaker unit 141 includes a data terminal circuit 1480 and a detach unit 1481 of memory card 110. Speaker unit 142 includes a power source 1490. Power source 1490 supplies power to data terminal circuit 1480 and the speaker (not shown) through wiring (not shown) disposed in support member 143. Support member 143 is formed of a leaf spring so as to have the two speaker units 141 and 142 cover respective ears of the user. Accordingly, the user can wear headphone 140 at his/her head. Data terminal circuit 1480 corresponds to a block diagram identical to that of remote controller 120 of FIG. 7.

Referring to FIG. 13 again, cellular phone 100 issues a distribution request of encrypted content data to distribution server 30 to receive a license key and encrypted content data, which are transmitted to data terminal circuit 1480 of headphone 140 through radio. Data terminal circuit 1480 transmits the received license key and encrypted content data to memory card 110. Memory card 110 stores the received license key and encrypted content data in memory 1415.

In response to a reproduction request from the user, data terminal circuit 1480 receives a license key and encrypted content data from memory card 110 to decrypt and reproduce encrypted content data in a manner described previously. Thus, the user can listen to music from speaker units 141 and 142.

According to the distribution system of FIG. 13, the user can wear headphone 140 to receive and reproduce the desired music from distribution server 30 with cellular phone 100 still in a bag or the like. The user can enjoy music over a long period of time by just wearing headphone 140 with both ears covered by speaker units 141 and 142.

The above description is based on a data terminal device (remote controller) of reproducing content data distributed to a memory card from a distribution server through a cellular phone network. However, in the present invention, distribution of content data to a memory card may be effected in a manner other than the above-described distribution system. For example, a distribution system that records a license key and encrypted content data into memory card through CD ripping can be employed.

In this case, cellular phone 100 and headphone 140 are connected to a computer. Remote controller 120 is directly connected to the computer, when an independent power source is incorporated. A CD-ROM in which encrypted content data is recorded is loaded in the CD-ROM drive connected to the computer.

Ripping refers to conversion of music data obtained from a music CD in a manner so as to be reproducible through a music reproduction module. First, a license key is generated with respect to the obtained music data. The obtained music data is converted into content data reproducible by remote controller 120 or data terminal device 140, and then encrypted in a form decryptable using the license key included in the generated license. The generated license of the encrypted content data obtained by ripping is supervised from being copied. Therefore, CD ripping corresponding to the primary copy from a music CD is a legal act protecting copyrights by implementing a structure that disables copying of encrypted content data and the license including a license key that is a decryption key thereof.

In the present invention, distribution of content data to a memory card may be effected by a distribution system other than the above-described system. For example, content data may be distributed to a memory card through the Internet. The present invention is applicable to any distribution system as long as encrypted data and a license key used to decrypt the encrypted data are distributed.

Although the present invention has been described and illustrated in detail, it is clearly understood that the same is by way of illustration and example only and is not to be taken by way of limitation, the spirit and scope of the present invention being limited only by the terms of the appended claims.

What is claimed is:

1. A data terminal device receiving encrypted data that is an encrypted version of data and a license key that is a decryption key used to decrypt said encrypted data to obtain said data from a portable terminal apparatus that receives said encrypted data and said license data, and transmitting said received encrypted data and license data to a data recording device, and reproducing said encrypted data from said data recording device, said data terminal device comprising:
a first interface unit to transfer data with said portable terminal apparatus,
a second interface unit to transfer data with said data recording device,
an authentication data hold unit storing a pre-assigned authentication data to be output to said data recording device,
a decryption processing unit decrypting said encrypted data using said license key, and
a control unit,
wherein said control unit receives said encrypted data and said license data from said portable terminal apparatus via said first interface unit to transmit the received encrypted data and license key to said data recording device via said second interface unit in a data distribution mode, and
wherein said control unit transmits said authentication data to said data recording device via said second interface unit to receive said license key and said encrypted data transmitted from said data recording device in response to authentication of said authentication data in said data recording device, and applying the received license key and encrypted data to said decryption processing unit in a data reproduction mode.

2. The data terminal device according to claim 1, wherein said first interface unit receives driving power from said portable terminal apparatus.

3. The data terminal device according to claim 1, further comprising a power control unit controlling driving power.

4. The data terminal device according to claim 1, wherein said first interface unit receives said encrypted data and said license key from said portable terminal apparatus through wire.

5. The data terminal device according to claim 3, wherein said first interface unit receives said encrypted data and said license key through radio communication from said portable terminal apparatus.

6. The data terminal device according to claim 1, further comprising a key operation unit connected to said control unit to receive a reproduction request from a user,
wherein said control unit, upon receiving said reproduction request via said key operation unit, transmits said authentication data to said data recording device via said second interface unit, and receives said license key and said encrypted data sent from said data recording device in response to authentication of said authentication data in said data recording device to apply said received license key and encrypted data to said decryption processing unit in a data reproduction mode.

7. The data terminal device according to claim 1, further comprising:
a session key generator generating a first session key to obtain said license key from said data recording device, and
an encryption processing unit encrypting said first session key using a second session key obtained from said data recording device based on authentication of said authentication data in said data recording device,
wherein said decryption processing unit comprises
a first decryption processing unit decrypting said license key encrypted by said first session key, and
a second decryption processing unit decrypting said encrypted data using said license key decrypted at said first decryption processing unit,
wherein said control unit further applies said second session key to said encryption processing unit, applies the license key encrypted by said first session key to said first decryption processing unit, and applies said encrypted data to said second decryption processing unit.

8. The data terminal device according to claim 7, further comprising:
a key hold unit storing a private decryption key asymmetric to a public encryption key included in said authentication data, and
a third decryption processing unit decrypting said second session key encrypted by said public encryption key using said private decryption key,
wherein said control unit receives said second session key encrypted by said public encryption key from said data recording device, and applies said second session key to said third decryption processing unit, and applies the second session key decrypted at said third decryption processing unit to said encryption processing unit in a data reproduction mode.

9. The data terminal device according to claim 1, wherein said encrypted data includes encrypted music data,
said portable terminal apparatus is a portable cellular phone,
said data terminal device further comprising:
a music reproduction unit reproducing music data decrypted by said decryption processing unit, and
a terminal to provide the music data reproduced by said music reproduction unit to an external output device.

10. A headphone device comprising:
a first speaker unit including a power source, and
a second speaker unit including a detach unit to attach or detach a data recording device, and a data terminal circuit,
wherein said data terminal circuit comprises
a first interface unit to transfer data with a portable terminal apparatus that receives encrypted data and a license key used to decrypt said encrypted data,
a second interface unit to transfer data with said data recording device,
an authorization data hold unit storing authentication data with respect to said data recording device,
a decryption processing unit decrypting said encrypted data using said license key, and
a control unit,
wherein said control unit receives said encrypted data and said license key from said portable terminal apparatus via said first interface unit to send the received encrypted data and license key to said data recording device via said second interface unit in a data distribution mode,
wherein said control unit transmits said authentication data to said data recording device via said second interface unit, and receives said license key and said encrypted data transmitted from said data recording device in response to authentication of said authentication data in said data recording device to apply the received license key and encrypted data to said decryption processing unit in a data reproduction mode.

11. The headphone device according to claim 10, wherein said data recording device comprises
a memory storing said encrypted data and said license key,
an authentication key hold unit storing a public authentication key used to decrypt said authentication data, and
an authentication data decryption processing unit decrypting said authentication data using said public authentication key, and
a control unit,
wherein said control unit applies the authentication data transmitted from said data terminal circuit to said authentication data decryption processing unit to have authenticity of said data terminal circuit verified based on authentication data decrypted by said authentication data decryption processing unit, and then reads out said encrypted data and said license data from said memory to transmit said encrypted data and said license key to said data terminal circuit in a data reproduction mode.
